(19) United States
(12) Patent Application Publication
(10) Pub. No.: US 2008/0100746 A1
(43) Pub. Date: May 1, 2008

(54) TV capture unit and information processing apparatus

(75) Inventor: Toshikazu Mukaiyama, Nishitama-gun (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba, Tokyo (JP)

(21) Appl. No.: 11/872,460

(22) Filed: Oct. 15, 2007

(30) Foreign Application Priority Data
Oct. 31, 2006 (JP) JP 2006-297057

(51) Int. Cl. H04N 7/00

(52) U.S. Cl. 348/552; 348/E07.091

(57) ABSTRACT

According to one embodiment, a TV capture unit includes a wiring board. a first device provided with a first TV tuner and a second device provided with a second TV tuner are mounted on the wiring board. The wiring board includes terminals which are provided in correspondence to pins of the bus slot, and wiring lines which connect part of the terminals to the first and second devices. The wiring lines includes signal lines used for connection between a terminal corresponding to an unused pin to which no particular signal is assigned in pin assignment of an interface standard complied with by the bus slot or a terminal corresponding to a pin to which a signal irrelevant to an operation of a TV tuner is assigned and one of the first and second devices.

### CROSS-REFERENCE TO RELATED APPLICATIONS

This application is based upon and claims the benefit of priority from Japanese Patent Application No. 2006-297057, filed Oct. 31, 2006, the entire contents of which are incorporated herein by reference.

### BACKGROUND

1. Field

One embodiment of the present invention relates to a TV capture unit capable of receiving TV broadcast signals, and also to an information processing apparatus provided with the unit.

2. Description of the Related Art

Various types of information processing apparatuses (such as personal computers) include a type provided with a TV tuner. In comparatively small-sized computers such as a notebook type, TV tuners are realized as a device based on the MiniPCI standard.

Various technologies are known regarding the MiniPCI. For example, Jpn. Pat. Appln. KOKAI Publication No. 2003-44422 discloses a computer system wherein a MiniPCI connector for providing MiniPCI is connected to a peripheral component interconnect (PCI) bus and is also connected to an I/O bridge (core chip) through an AC-LINK.

When TV tuners of different types (such as a terrestrial digital TV tuner and a ground analog TV tuner) are installed in one information processing apparatus as devices based on the MiniPCI standard, MiniPCI slots equal in number to the TV tuners must be provided, and TV tuner cards (or capture cards) must be inserted in the slots. However, the installation areas of the tuner cards require are considerable, and the manufacturing cost inevitably increases. This is undesirable in the case of information processing apparatuses that require downsizing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of the outward appearance of an information processing apparatus according to one embodiment of the present invention;

FIG. 2 is an exemplary block diagram showing an example of a system configuration of the information processing apparatus of FIG. 1;

FIG. 3 shows an exemplary manner in which a PCI device for digital TVs and a PCI device for analog TVs are mounted according to the embodiment;

FIG. 4 shows an exemplary manner in which a PCI device for digital TVs and a PCI device for analog TVs are mounted according to the prior art;

FIG. 5 shows an exemplary pin assignment table (the first half portion) based on the miniPCI standard;

FIG. 6 shows an exemplary pin assignment table (the second half portion) based on the miniPCI standard; and

FIG. 7 is an exemplary flowchart illustrating how an operation is performed according to the configuration cycle specified in PCI specifications.

### DETAILED DESCRIPTION

Various embodiments according to the invention will be described hereinafter with reference to the accompanying drawings. In general, according to one embodiment of the invention, there is provided a TV capture unit detachably inserted into a bus slot connected to a predetermined bus. The TV capture unit includes a first device provided with a first TV tuner and having an interface function that enables communications with the bus, a second device provided with a second TV tuner and having an interface function that enables communications with the bus, and a wiring board on which the first device and the second device are mounted, the wiring board including terminals which are provided in correspondence to pins of the bus slot, and wiring lines which connect part of the terminals to the first and second devices. The wiring lines includes signal lines used for connection between a terminal corresponding to an unused pin to which no particular signal is assigned in pin assignment of an interface standard complied with by the bus slot or a terminal corresponding to a pin to which a signal irrelevant to an operation of a TV tuner is assigned and one of the first and second devices.

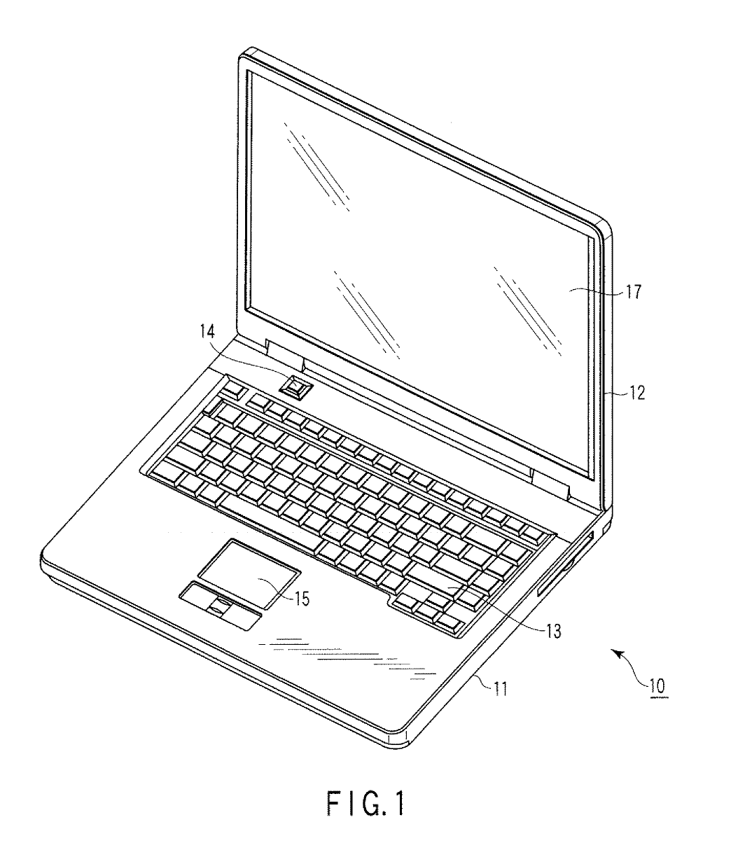

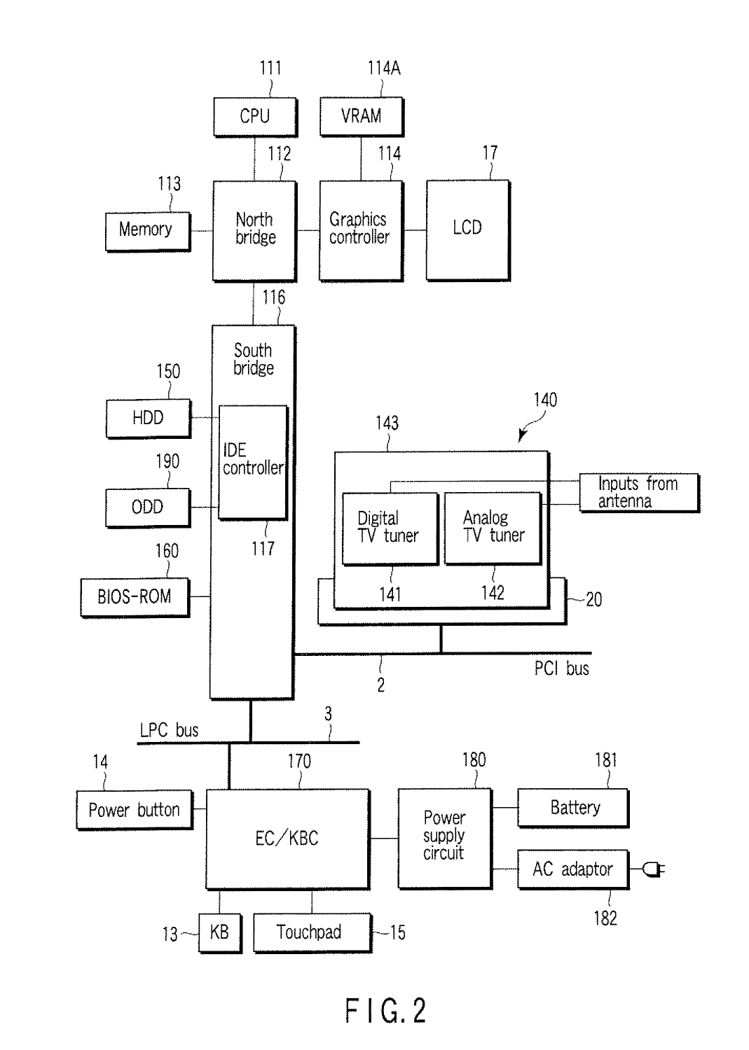

First, a description will be given with reference to FIGS. 1 and 2 of the configuration of the information processing apparatus according to one embodiment of the present invention. The information processing apparatus is, for example, a notebook type portable personal computer 10 that can be driven by a battery.

FIG. 1 is a perspective diagram of the portable personal computer 10 and shows the state in which a display unit is open. The computer 10 includes a computer main body 11 and a display unit 12. In the computer main body 11, a system board (which is also referred to as a mother board) has various kinds of electronic components mounted thereon. The system board is made by a printed circuit board (PCB).

The display unit 12 includes a display device made by a liquid crystal display (LCD) 17. The display screen of the LCD 17 is located substantially in the center of the display unit 12.

The display unit 12 is rotatable relative to the computer main body 11 between an open position and a closed position. The computer main body 11 has a casing in the form of a thin box. A keyboard 13, a power button switch 14 used for turning on/off the personal computer 10, a touchpad 15, etc. are arranged on the upper surface of the casing.

FIG. 2 shows an example of a system configuration of the computer 10.

As shown in FIG. 2, the computer 10 is provided with the following structural elements: a PCI bus 2, an LPC bus 3, CPU 111, a north bridge 112, a main memory 113, a graphics controller 114, a south bridge 116, a TV capture unit (or a TV tuner unit) 140, a hard disk drive (HDD) 150, a BIOS-ROM 160, an embedded controller/keyboard controller (EC/KBC) 170, a power supply circuit 180, and an optical disk drive (ODD) 190. The CPU 111, north bridge 112, main memory 113, graphics controller 114, south bridge 116, BIOS-ROM 160, embedded controller/keyboard controller (EC/KBC) 170 and power supply circuit 180, are mounted on the system board.

The CPU 111 is a processor for controlling the operation of the computer 10 and executes the operating system (OS) and various types of applications/utility programs loaded into the main memory 113 from the hard disk drive (HOD) 150. The CPU 111 also executes a basic input/output system (BIOS) stored in BIOS-RON 160.

The north bridge 112 is a bridge device that connects the local bus of CPU 111 and the south bridge 116. The north bridge 112 also has the function of performing communications with the graphics controller 114 by means of an accelerated graphics port (AGP) bus or the like.

The graphics controller 114 is a display controller that controls the LCD 17, which is used as the display monitor of the computer 10. The graphics controller 114 includes a video memory (VRAM) 114A, and a display signal to be sent to the LCD 17 is generated on the basis of the image data which the OS/application program writes in the video memory 114A.

The south bridge 116 is connected to the PCI bus 2 and the low pin count (LPC) bus 3. The PCI bus 2 is a bus used for the data transfer between various types of devices. The PCI bus 2 is electrically connected to the CPU 111 through the south bridge 116 and the north bridge 112. The CPU 111 can perform communications with various devices on the PCI bus 2 through the PCI bus 2.

The south bridge 116 is provided with an integrated drive electronics (IDE) controller 117 for controlling the HDD 150 and ODD 190.

A MiniPCI slot (bus slot) 20 is connected to the PCI bus 2. This MiniPCI slot 20 is a bus slot provided with a connector which has 124 pins based on the MiniPCI standard. The TV capture unit 140 is connected to the MiniPCI slot 20.

The TV capture unit 140 is realized as a card or a board based on the MiniPCI standard and is detachably connectable to the MiniPCI slot 20. The TV capture unit 140 is connected to the PCI bus 2 through the MiniPCI slot 20 and receives encoded broadcast program data under the control of the CPU 111.

The above-mentioned TV capture unit 140 has two PCI devices incorporating different types of TV tuners. To be more specific, the two PCI devices have an interface function of communicating with the PCI bus 2 and are made, for example, by the following: (i) a one-chip PCI device (first device) 141 including a digital TV tuner (first TV tuner) capable of receiving terrestrial digital TV broadcast signals (the PCI device will be hereinafter referred to as a “digital-TV PCI device”) and (ii) a one-chip PCI device (second device) 142 including an analog TV tuner (second TV tuner) capable of receiving terrestrial analog TV broadcast signals (the PCI device will be hereinafter referred to as an “analog-TV PCI device”). The digital-TV PCI device 141 and the analog-TV PCI device 142 receive broadcast program data by means of external antennas. For example, the digital-TV PCT device 141 receives a digital broadcasting signal and executes a decoding process (i.e., a descrambling process). In the decoding process, the digital-TV PCI device 141 demodulates the received digital broadcast signal so as to obtain a transport stream (TS) corresponding to the broadcast program data of a predetermined channel from the received digital broadcasting signal, and decodes the transport stream.

The embedded controller/keyboard controller (EC/KBC) 170 is a one-chip microcomputer in which an embedded controller for power management and a keyboard controller for controlling the keyboard 13 and touchpad 15 are integrated. When the power switch 14 is depressed by the user, the EC/KBC 170 cooperates with the power supply circuit 180 and turns on the computer.

The power supply circuit 180 generates system power to be supplied to the components of the computer 10, by using external power supplied thereto from a battery 181 or an AC adaptor.

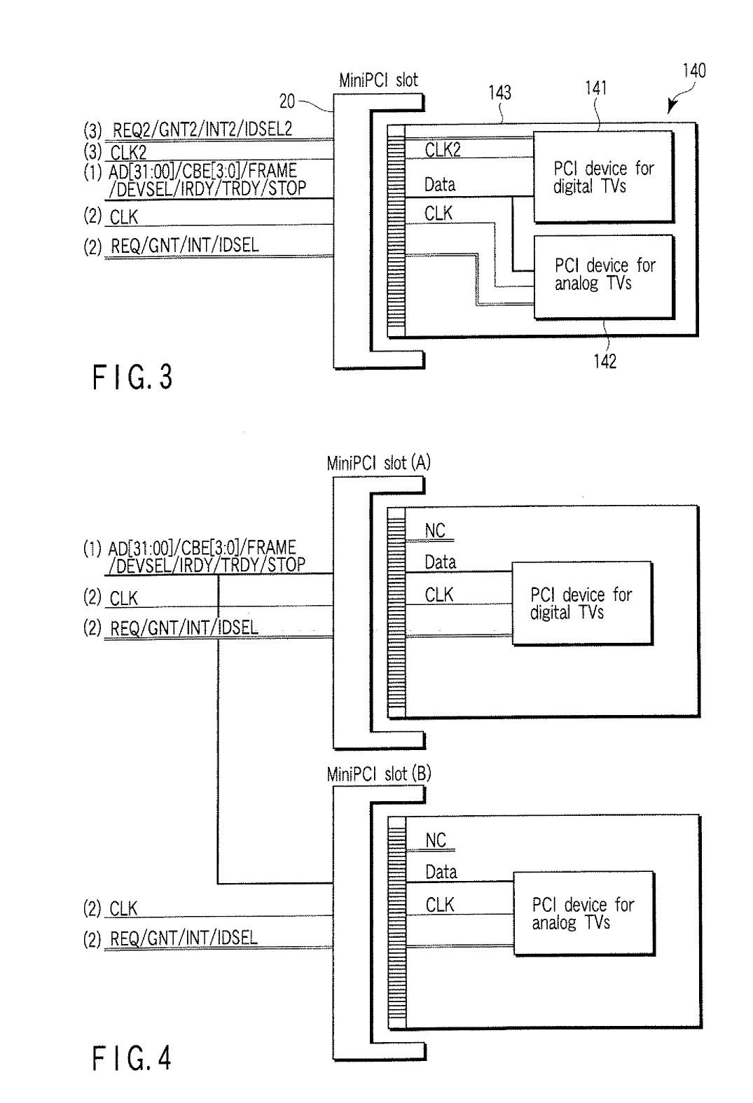

A description will now be given with reference to FIGS. 3 to 6 of the technology for mounting the digital-TV PCI device 141 and the analog-TV PCI device 142.

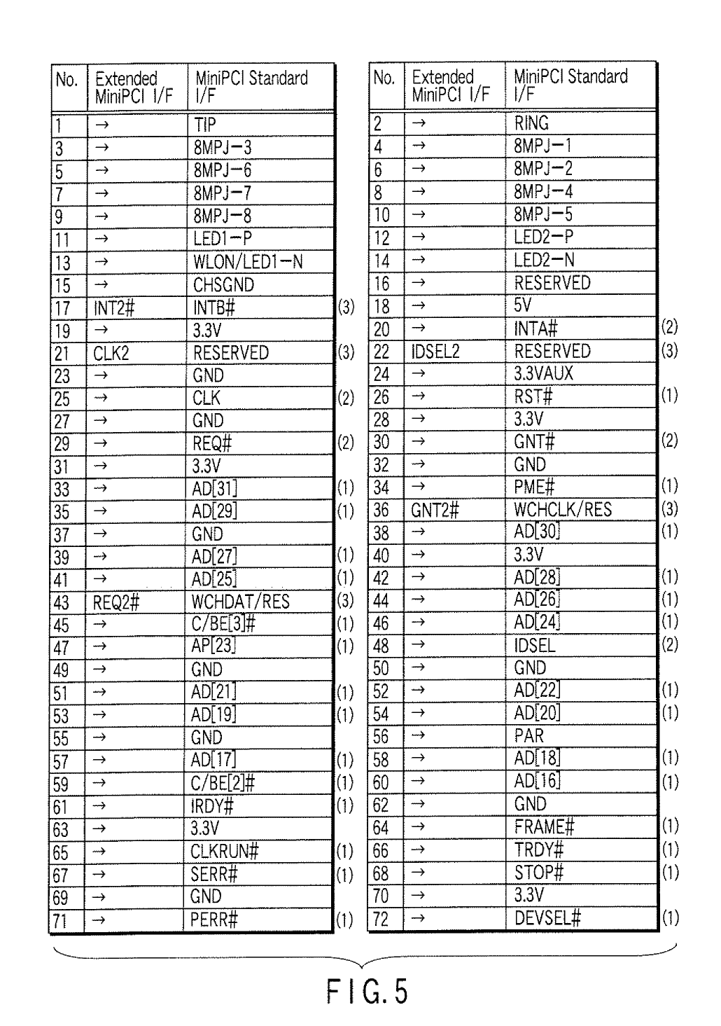

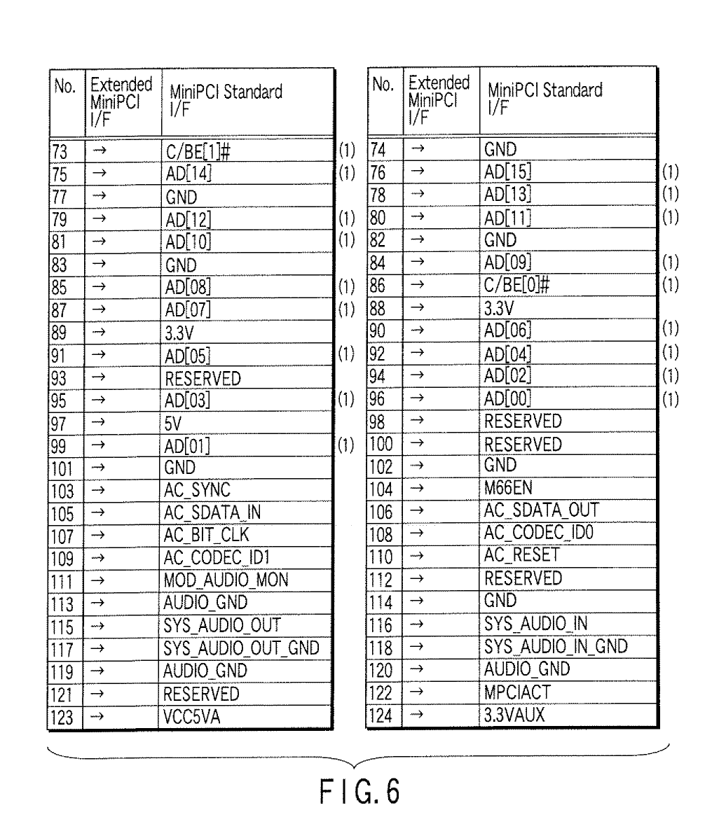

FIG. 3 shows an example of a mounting method according to the embodiment. FIG. 4 shows an example of the conventional mounting method. FIGS. 5 and 6 show a pin assignment table based on the miniPCI standard. In the pin assignment table, “MiniPCI Standard IF” indicates standard signal assignment determined based on the miniPCI standard, and “Extended MiniPCI I/F” indicates extended signal assignment that enables two PCI devices to be mounted in the same mini PCI slot. (In the table, the right arrow indicates that the assignment method is the same as that of the “MiniPCI Standard I/F.”

In FIGS. 3 to 6, the parenthetic numbers “1”, “2” and “3” represent types of signals. To be more specific, parenthetic number “1” represents a signal line which can be connected to different PCI devices. Parenthetic number “2” represents a signal line which has to be connected to each individual device in a point-to-point manner. Parenthetic number “3” represents a signal line which has to be connected to each individual device in a point-to-point manner and which is assigned to an unused pin in the standard pin assignment so as to permit a second PCI device to be mounted in the embodiment.

As shown in FIG. 3, the TV capture unit 140 of the present embodiment is fabricated by mounting both the digital-TV PCI device 141 and the analog-TV PCI device 142 on a single wiring board 143.

The wiring board 143 includes 124 terminals corresponding to the 124 pins of the MiniPCI slot 20, and wiring lines for connecting part of these terminals to the digital-TV PCI device 141 and the analog-TV PCI device 142. The wiring lines include signal lines used for connection between the terminal corresponding to an unused pin (i.e., a pin to which no particular signal is assigned in the pin assignment of the interface standard [miniPCI standard] complied with by the MiniPCI slot 20) or the terminal corresponding to a pin to which a signal irrelevant to the operation of a TV tuner is assigned and one of the digital-TV PCI device 141 and the analog-TV PCI device 142 (for example, the analog-TV PCI device 142).

In order to realize a double tuner function in an image processing apparatus, the conventional technology uses two mini PCI slots and provides two TV tuner cards in the slots, as shown in FIG. 4. In this case, the signal lines between the PCI bus and the two miniPCI slots include (i) signal lines used in common to the slots (the signal lines are indicated by parenthetic number “1” and are, for example, an address/data transfer bus [AD], a command signal line [C/BE], a control signal line [FRAME, DEVSEL, IRDY, TRDY, STOP or the like]), and (ii) pairs of signal lines connected to each slot in a point-to-point manner (the signal lines are indicated by parenthetic number “2” and are, for example, control signal lines [REQ, GNT, INT, IDSEL] and clock signal lines [CLK]). In conformity with this, on the wiring board of each TV tuner card, the address/data transfer bus of parenthetic number “1”, the clock signal lines and control signal lines of parenthetic number “2” are connected in parallel with one another between the PCI device and the terminals to be connected to the slot.

In order to realize a double TV tuner by use of one miniPCI slot, pairs of signal lines of parenthetic number “2” have to be connected to one miniPCI slot. According to the standard interface of the MiniPCI, however, only one pair of signals are assigned as signals of parenthetic number “2”, and, in principle, only one PCI device is connectable.

To solve this problem, the present embodiment assigns a second pair of signal lines of parenthetic number “2” to unused pins of the standard interface of the MiniPCI. The signal lines assigned to the unused pins correspond to the signal lines of parenthetic number “3” shown in FIG. 3 (such as control signal lines [REQ2, GNT2, INT2, INDSEL2] and clock signal lines [CLK2]). With this configuration, as shown in FIG. 3, the following signal lines are connected between the PCI bus and the miniPCI slot 20: the signal lines of parenthetic number “1”which are used in common to the two PCI devices 141 and 142; signal lines of parenthetic number “2” which correspond to PCI device 142, and signal lines of parenthetic number “3” which correspond to PCI device 141. In conformity with this, on the wiring board 143 of the TV capture unit 140, signal lines of parenthetic number “1” and signal lines of parenthetic number “2” are provided between PCI device 142 and the terminals connected to the miniPCI slot 20. In addition, signal lines of parenthetic number “1” and signal lines of parenthetic number “3” are provided between PCI device 141 and the terminals connected to the miniPCI slot 20. In this case, the signal lines of parenthetic number “1” are used in common to the two PCI devices 141 and 142.

As described above, a double TV tuner function is realized by use of one miniPCI slot by modifying the hardware (i.e., the wiring lines on the wiring board 143) and with no need to modify the software.

As seen in the pin assignment table shown in FIGS. 5 and 6, the signal lines of parenthetic number “3” are assigned to pin numbers “17”, “21”, “22”, “36” and “43”, for example.

Although “INTB#” is assigned to pin number “17” in “MiniPCI Standard I/F”, “INT2#” is assigned to that pin number in “Extended MiniPCI I/F”. In this case, “INTA#” of pin number “20” is used for PCI device 142, while “INT2#” of pin number “17” is used for PCI device 141.

“RESERVED” is assigned to pin number “21” in “MiniPCI Standard I/F” (this means that pin number “21” is unused). In “Extended MiniPCI I/F”, “CLK2” is assigned instead. In this case, “CLK” of pin number “25” is used for PCI device 142, while “CLK2” of pin number “21” is used for PCI device 141.

“RESERVED” is assigned to pin number “22” in “MiniPCI Standard I/F” (this means that pin number “22” is unused). In “Extended MiniPCI I/F”, “IDSEL2” is assigned instead. In this case, “IDSEL” of pin number “148” is used for PCI device 142, while “IDSEL2” of pin number “22” is used for PCI device 141.

In “MiniPCI Standard I/F”, “WCHCLK/RES” (i.e., a signal exchanged to solve problems resulting from the interference between a wireless LAN and the Bluetooth®) is assigned to pin number “36”. In “Extended MiniPCI I/F”, however, “GNT2#” is assigned instead. In this case, “GNT#” of pin number “30” is used for PCI device 142, while “GNT2#” of pin number “36” is used for PCI device 141.

In “MiniPCI Standard I/F”, “WCHDAT/RES” (i.e., a signal exchanged to solve problems resulting from the interference between a wireless LAN and the Bluetooth®) is assigned to pin number “43”. In “Extended MiniPCI I/F”, however, “REQ2#” is assigned instead. In this case, “REQ#” of pin number “29” is used for PCI device 142, while “REQ2#” of pin number “43” is used for PCI device 141.

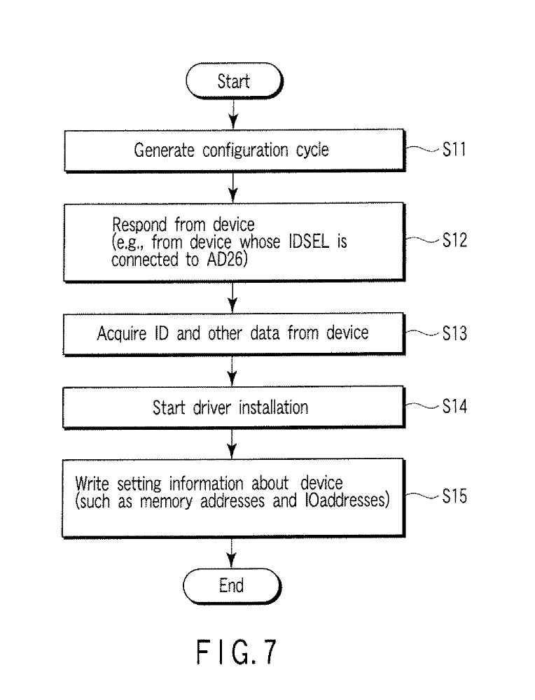

A description will now be given with reference to FIG. 7 of an operation performed in accordance with the configuration cycle specified in the PCI specifications.

When the power supply of the computer 10 has been turned on, the configuration cycle by a PCI host is generated under the control of the OS (block S11). As a result, a PCI device connected to PCI bus 2 is detected by means of each “AD” and each “C/BE#” on the PCI bus.

Each of the PCI devices (including PCI devices 141 and 142 mounted on the TV capture unit 143) responds to the above-mentioned configuration cycle (block S12).

Let us assume that the PCI device whose “IDSEL” is connected to “AD26” responds to the configuration cycle. In this case, the PCI host acquires ID and other data from the PCI device (block S13), starts driver installation (block S14), and executes an operation of writing the setting information about the PCI device (such as memory addresses and IO addresses) (block S15).

As a result of the above operations, an application can use the PCI device through the use of the PCI bus 2.

As detailed above, the present embodiment has enabled both the digital-TV PCI device 141 and the analog-TV PCI device 142 to be suitably mounted on one TV capture unit. Therefore, the TV capture unit can be fabricated with a high degree of integration. Moreover, in the state where the TV capture unit described above is provided in one miniPCI slot, the digital-TV PCI device 141 and the analog-TV PCI device 142 can be operated without any problems through the use of the PCI bus 10 and the miniPCI slot.

While certain embodiments of the inventions have been described, these embodiments have been presented by way of example only, and are not intended to limit the scope of the inventions. Indeed, the novel methods and systems described herein may be embodied in a variety of other forms; furthermore various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A TV capture unit detachably inserted into a bus slot connected to a predetermined bus, comprising:
a first device provided with a first TV tuner and having an interface function that enables communications with the bus;
a second device provided with a second TV tuner and having an interface function that enables communications with the bus; and
a wiring board on which the first device and the second device are mounted, the wiring board including terminals which are provided in correspondence to pins of the bus slot, and wiring lines which connect part of the terminals to the first and second devices,
the wiring lines including signal lines used for connection between a terminal corresponding to an unused pin to which no particular signal is assigned in pin assignment of an interface standard complied with by the bus slot or a terminal corresponding to a pin to which a signal irrelevant to an operation of a TV tuner is assigned and one of the first and second devices.

2. The TV capture unit according to claim 1, wherein the first device includes a TV tuner capable of receiving digital TV broadcast signals, and the second device includes a TV tuner capable of receiving analog TV broadcast signals.

3. The TV capture unit according to claim 1, wherein the signal lines include a signal line that realizes point-to-point connection.

4. The TV capture unit according to claim 1, wherein the interface standard is a miniPCI standard.

5. The TV capture unit according to claim 1, wherein the signal lines include a signal line connected to a terminal corresponding to one of a “RESERVED” pin, a “WCHDAT/RES” pin and a “WCHDAT/RES” pin.

6. An information processing apparatus comprising:
a system board;
a bus slot connected to a predetermined bus provided on the system board; and
a TV capture unit detachably inserted into the bus slot,
the TV capture unit comprising:
a first device provided with a first TV tuner and having an interface function that enables communications with the bus;
a second device provided with a second TV tuner and having an interface function that enables communications with the bus; and
a wiring board on which the first device and the second device are mounted, the wiring board including terminals which are provided in correspondence to pins of the bus slot, and wiring lines which connect part of the terminals to the first and second devices,
the wiring lines including signal lines used for connection between a terminal corresponding to an unused pin to which no particular signal is assigned in pin assignment of an interface standard complied with by the bus slot or a terminal corresponding to a pin to which a signal irrelevant to an operation of a TV tuner is assigned and one of the first and second devices.

7. The information processing apparatus according to claim 6, wherein the first device includes a TV tuner capable of receiving digital TV broadcast signals, and the second device includes a TV tuner capable of receiving analog TV broadcast signals.

8. The information processing apparatus according to claim 6, wherein the signal lines include a signal line that realizes point-to-point connection.

9. The information processing apparatus according to claim 6, wherein the interface standard is a miniPCI standard.

10. The information processing apparatus according to claim 6, wherein the signal lines include a signal line connected to a terminal corresponding to one of a “RESERVED” pin, a “WCHDAT/RES” pin, and a “WCHDAT/RES” pin.
